(19) United States
(12) Patent Application Publication
(10) Pub. No.: US 2012/0032931 A1
(43) Pub. Date: Feb. 9, 2012

(54) DUAL-VIEW DISPLAY DEVICE AND DISPLAY METHOD THEREOF

(75) Inventors: CHING-LUNG LI, Fengshan City (TW); Jhen-shen Liao, Bade City (TW); Hung-hsiang Chen, Zhongli City (TW)

(73) Assignee: CHUNGHWA PICTURE TUBES, LTD., Bade City (TW)

(21) Appl. No.: 12/954,613

(22) Filed: Nov. 24, 2010

(30) Foreign Application Priority Data
Aug. 4, 2010 (TW) 099126008

(51) Int. Cl. G09G 5/00; G09G 3/36

(52) U.S. Cl. 345/204; 345/87

(57) ABSTRACT

A dual-view display device and a display method thereof are disclosed. The dual-view display device includes a backlight module, an optical film, a liquid crystal display panel, and a main control unit. The backlight module includes a light guide plate, a left light source, and a right light source. The optical film is disposed in front of the backlight module. The liquid crystal display panel is disposed in front of the optical film. The main control unit is electrically coupled to the left light source, the right light source, and the liquid crystal display panel. The main control unit transmits an image data to the liquid crystal display panel and controls the left and right light sources according to the image data, so as to control the liquid crystal display panel adaptively to display an identical image, one view image, or dual-view images.

### TECHNICAL FIELD OF THE INVENTION

The present invention relates to a display device, and more particularly, to a dual-view display device and a display method thereof.

### BACKGROUND OF THE INVENTION

Generally, a liquid crystal display device is required to provide only one frame of image a time to satisfy users' demands. However, technologies have been become more and more progressive, and the liquid crystal display device is now required to provide plural frames of images at the same time to satisfy users' demands depending on situations. For example, the liquid crystal display device that is widely utilized in a car may display an information image of a global positioning system (GPS) for a driver to see, while at the same time displays a multimedia image for other passengers to watch. The driver and the passengers can respectively observe different images because the driver and the passengers have different viewing angles with respect to the liquid crystal display device.

Please refer to FIG. 1, which illustrates a conventional dual-view display device 1. Different observers at different viewing angles with respect to the dual-view display device 1 can see different images being displayed on the conventional dual-view display device 1. The conventional dual-view display device 1 mainly comprises a backlight module 10, a liquid crystal display panel 12, and a barrier substrate 14. The backlight module 10 is utilized for providing light required by the liquid crystal display panel 12. The barrier substrate 14 has slits 140 and barriers 142 disposed thereon. After the light passes through the liquid crystal display panel 12, some of the light will be projected through the slits 140 at a specific angle and some of the light will be blocked by the barriers 142. As a result, the different observers at different viewing angles can see different images.

Furthermore, the image data inputted to the liquid crystal display panel 12 have to be processed. That is, a left image for a left-side observer 70 and a right image for a right-side observer 80 have to be processed as a mixed image in advance. Then, the liquid crystal display panel 12 interlacedly displays the left image for the left-side observer 70 and the right image for the right-side observer 80. As a result, by the slits 140 and the barriers 142 on the barrier substrate 14, the left-side observer 70 can only see the left image and the right-side observer 80 can only see the right image.

However, there exist the following problems in the conventional dual-view display device 1 as shown in FIG. 1. First, since the barrier substrate 14 has to be disposed in front of the liquid crystal display panel 12, a light transmittance of the conventional dual-view display device 1 will be decreased and therefore affecting the image quality. The disposed barrier substrate 14 also increases power consumption. Second, each of the left image and the right image can only have one half of pixels of the mixed image, and accordingly each of the left image and right image can only have one half of resolution. Third, since the left image and the right image have to be processed into the mixed image, a more complicated design of a system end of the conventional dual-view display device 1 is required.

Therefore, there is a need for a solution to the above-mentioned problems in the conventional dual-view display device 1.

### SUMMARY OF THE INVENTION

To solve the drawbacks of the aforementioned prior art of having a low light transmittance, one half of resolution, and high power consumption, a primary objective of the present invention is to provide a dual-view display device and a display method thereof.

To accomplish the above-mentioned invention objective, the dual-view display device according to the present invention comprises a backlight module, an optical film, a liquid crystal display panel, and a main control unit. The backlight module comprises a light guide plate, a left light source disposed at a left side of the light guide plate, and a right light source disposed at a right side of the light guide plate. The optical film is disposed in front of the backlight module for refracting light passing through the light guide plate to a left-side observer and refracting light passing through the light guide plate to a right-side observer. The liquid crystal display panel is disposed in front of the optical film. The main control unit is electrically coupled to the left light source, the right light source, and the liquid crystal display panel. The main control unit transmits an image data to the liquid crystal display panel and controls the left light source and the right light source according to the image data, so as to control the liquid crystal display panel to display an identical image for both the left-side observer and the right-side observer to see, one view image for one of the left-side observer and the right-side observer to see, or dual-view images for the left-side observer and the right-side observer to see, respectively.

Further, in the display method of the dual-view display device, the dual-view display device comprises a backlight module, an optical film, a liquid crystal display panel, and a main control unit. The backlight module comprises a light guide plate, a left light source disposed at a left side of the light guide plate, and a right light source disposed at a right side of the light guide plate. The optical film is disposed in front of the backlight module. The liquid crystal display panel is disposed in front of the optical film. The main control unit is electrically coupled to the left light source, the right light source, and the liquid crystal display panel. The display method comprises following steps of: inputting an image data to the main control unit; and the main control unit transmitting the image data to the liquid crystal display panel and controlling the left light source and the right light source according to the image data, so as to control the liquid crystal display panel to display an identical image for both a left-side observer and a right-side observer to see, one view image for one of the left-side observer and the right-side observer to see, or dual-view images for the left-side observer and the right-side observer to see, respectively.

Since a barrier substrate is not essential to be disposed in front of the liquid crystal display panel in the dual-view display device and the display method thereof according to the present invention, the problems, such as a low light transmittance, one half of resolution, and high power consumption, do not exist. Further, the main control unit of the present invention controls the turning-on and turning-off of the left light source and the right light source according to the image data, and thereby an identical image, one view image, or dual-view images can be adaptively displayed.

### BRIEF DESCRIPTION OF THE DRAWINGS

FIG. 1 illustrates a conventional dual-view display device;

FIGS. 2 and 3 illustrate a dual-view display device and a control block diagram thereof according to an embodiment of the present invention;

FIG. 4 illustrates a second method for inputting the image data;

FIG. 5 illustrates waveform diagrams inputted to the dual-view controller by the GPU;

FIG. 6 illustrates a third method for inputting the image data;

FIG. 7 illustrates timing diagrams of scanning the images and controlling the left light source and the right light source when displaying dual-view images at 120 Hertz;

FIGS. 8(a) and 8(b) respectively illustrate timing diagrams of scanning the images and controlling the left light source and the right light source only when the right image R or the left image data L is displayed;

FIGS. 9(a) and 9(b) respectively illustrate timing diagrams of scanning the images and controlling the left light source and the right light source when the one same image is displayed at 120 Hz and 60 Hz; and

FIG. 10 illustrates a flow chart of a display method of a dual-view display device.

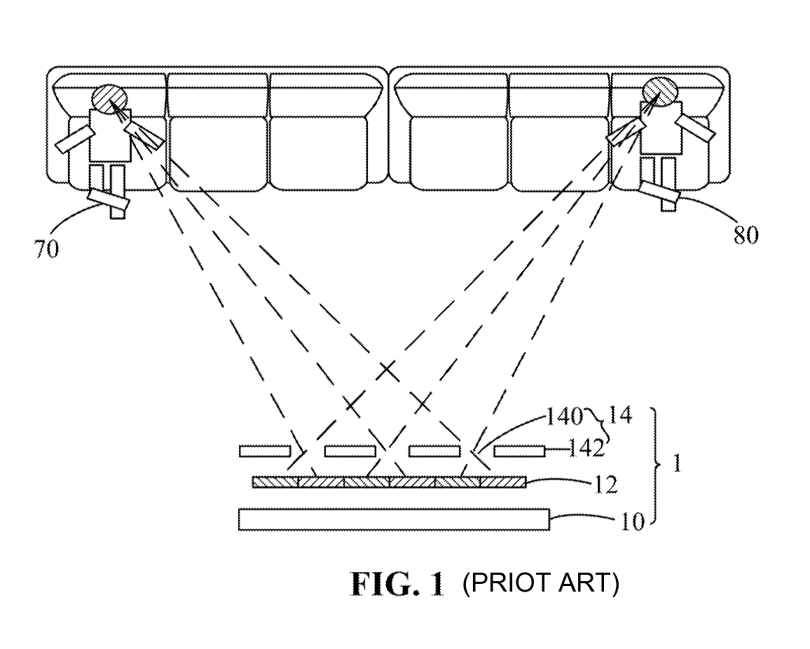

### DETAILED DESCRIPTION OF THE INVENTION

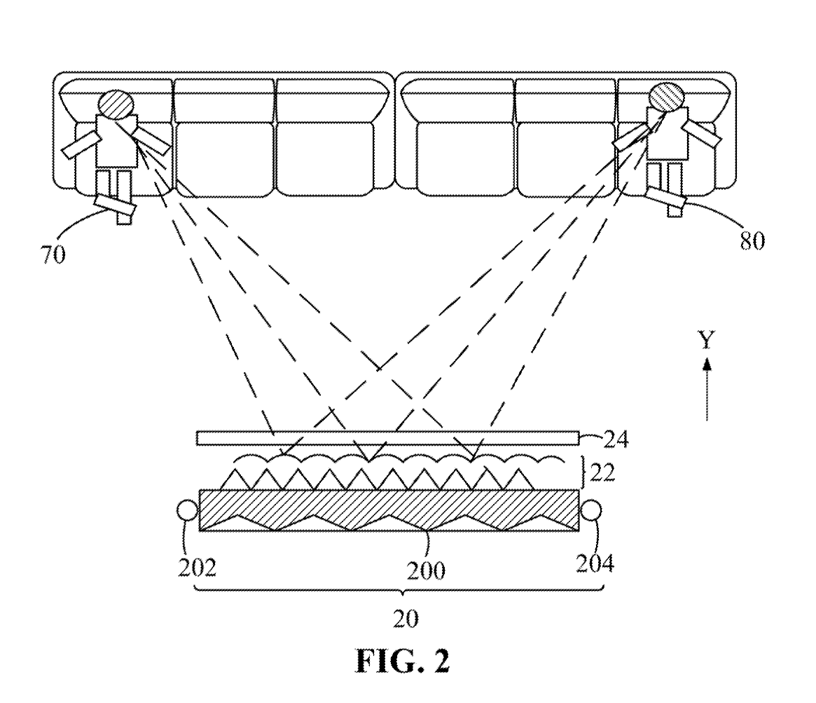

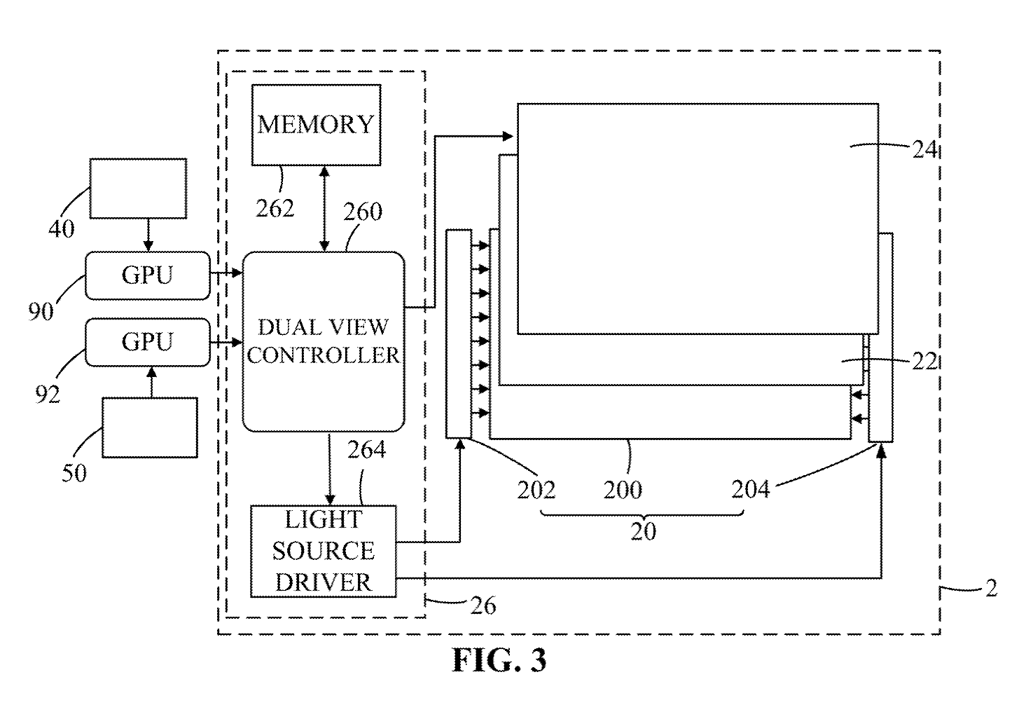

Please refer to FIGS. 2 and 3, which illustrate a dual-view display device 2 and a control block diagram thereof according to an embodiment of the present invention. The dual-view display device 2 comprises a backlight module 20, an optical film 22, a liquid crystal display panel 24, and a main control unit 26. The backlight module 20 comprises a light guide plate 200, a left light source 202 disposed at a left side of the light guide plate 200, and a right light source 204 disposed at a right side of the light guide plate 200. The optical film 22 is disposed in front of the backlight module 20 for refracting light passing through the light guide plate 200 to a left-side observer 70 and a right-side observer 80. The liquid crystal display panel 24 is disposed in front of the optical film 22. The main control unit 26 is electrically coupled to the left light source 202, the right light source 204, and the liquid crystal display panel 24. The main control unit 26 transmits an image data to the liquid crystal display panel 24 and controls the left light source 202 and the right light source 204 according to the image data, so as to control the liquid crystal display panel 24 to display an identical image for both the left-side observer 70 and the right-side observer 80 to see, one view image for one of the left-side observer 70 and the right-side observer 80 to see (for example, a left image for the left-side observer 70 to see or a right image for the right-side observer 80 to see), or dual-view images for the left-side observer 70 and the right-side observer 80 to see, respectively.

A distance from the liquid crystal display panel 24 to the left-side observer 70 or to the right-side observer 80 is usually at least 50 centimeter (cm). A distance between the left-side observer 70 and the right-side observer 80 is at least 100 cm. It can be known from experiments that a refraction angle between a normal line of the optical film 22 and the light refracted by the optical film 22 to the left-side observer 70 is at least greater than 40 degrees, that is, an angle between the light refracted to the left-side observer 70 and a direction Y is at least greater than 40 degrees. A refraction angle between the normal line of the optical film 22 and the light refracted by the optical film 22 to the right-side observer 80 is at least greater than 40 degrees, that is, an angle between the light refracted to the right-side observer 80 and the direction Y is at least greater than 40 degrees.

The main control unit 26 comprises a dual-view controller 260, a memory 262 being electrically coupled to the dual-view controller 260, and a light source driver 264 being electrically coupled to the dual-view controller 260. The image data received by the main control unit 26 comprises a left image data 40 and a right image data 50. The present invention discloses three methods for inputting the left image data 40 and the right image data 50. A first method is as shown in FIG. 3, the left image data 40 and the right image data 50 are inputted to the dual-view controller 260 in parallel via two graphics processing units (GPUs) 90, 92. The dual-view controller 260 stores the left image data 40 and the right image data 50 in the memory 262, such as a synchronous dynamic random access memory (SDRAM). Then, the dual-view controller 260 reads the left image data 40 and the right image data 50 and outputs the left image data 40 and the right image data 50 to the liquid crystal display panel 24 in turn. According to the outputs of the dual-view controller 260, the light source driver 264 controls turning-on and turning-off of the left light source 202 and the right light source 204, so as to achieve an object of displaying dual-view images. In detail, when the dual-view controller 260 reads the left image data 40 and outputs the left image data 40 to the liquid crystal display panel 24, the dual-view controller 260 controls the light source driver 264 to turn on the left light source 202 and turn off the right light source 204. When the dual-view controller 260 reads the right image data 50 and outputs the right image data 50 to the liquid crystal display panel 24, the dual-view controller 260 controls the light source driver 264 to turn on the right light source 204 and turn off the left light source 202.

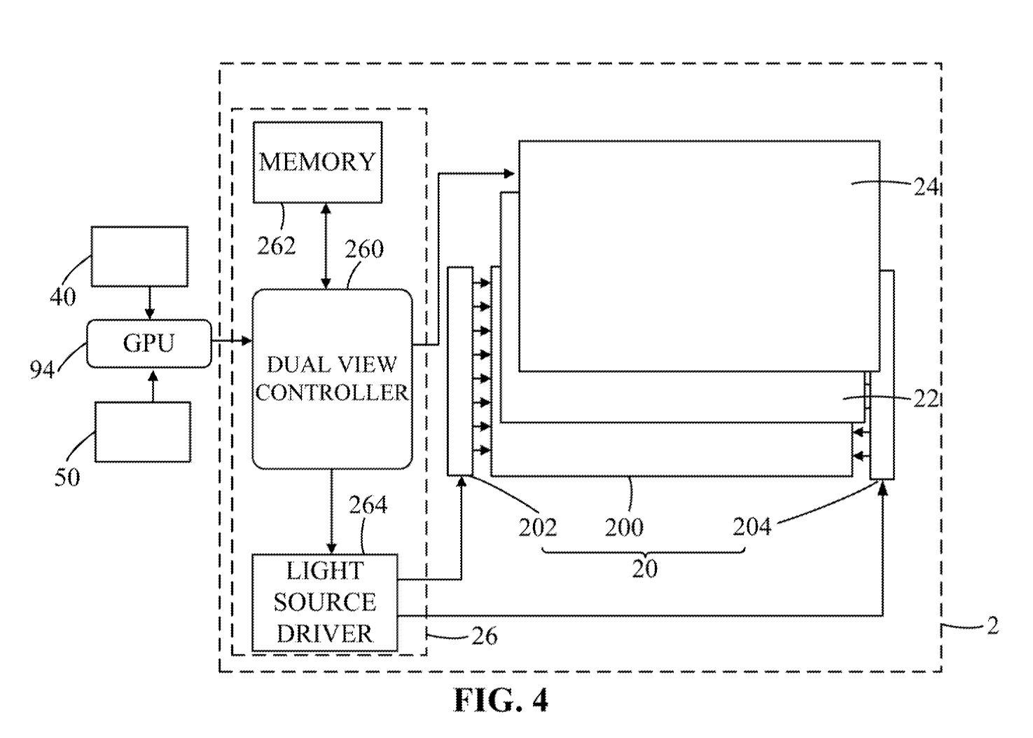

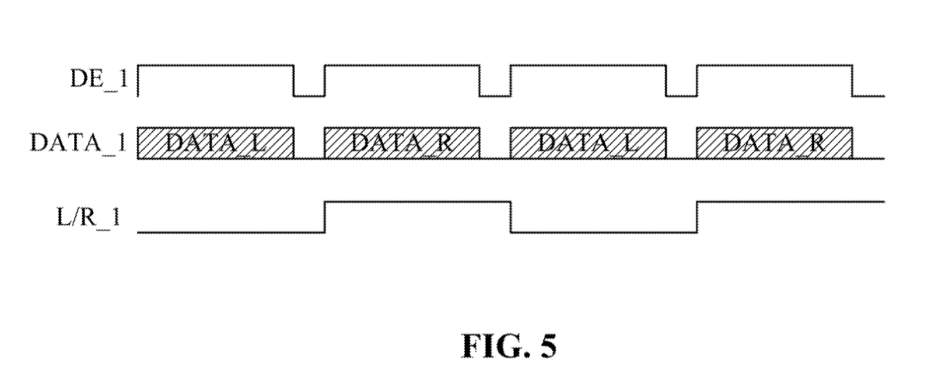

Please refer to FIGS. 2 and 4. FIG. 4 illustrates a second method for inputting the image data. The left image data 40 and the right image data 50 are inputted to a GPU 94, and the GPU 94 sequentially inputs the left image data 40 and the right image data 50 to the dual-view controller 260. Please refer to FIG. 5, which illustrates waveform diagrams inputted to the dual-view controller 260 by the GPU 94. When a data enable signal DE_1 is at a high level, a data signal DATA_1 including the left image data 40 and the right image data 50 is regarded as valid. Since both the left image data 40 and the right image data 50 are inputted to the dual-view controller 260 by the GPU 94, the GPU 94 is required to provide an indication signal L/R_1 so that the dual-view controller 260 determines the data signal DATA_1 is the left image data 40 or the right image data 50. For example, when the indication signal L/R_1 is at a low level as shown in FIG. 5, the data signal DATA_1 represents the left image data 40. When the indication signal L/R_1 is at a high level, the data signal DATA_1 represents the right image data 50. After the dual-view controller 260 receives the left image data 40 and the right image data 50 which are sequentially inputted, the following process is the same as the process of the first method. That is, the main controller 260 stores the left image data 40 and the right image data 50 in the memory 262. Then, the dual-view controller 260 reads the left image data 40 and the right image data 50 and outputs the left image data 40 and the right image data 50 to the liquid crystal display panel 24 in turn. Next, the light source driver 264 controls turning-on and turning-off of the left light source 202 and the right light source 204 according to the outputs of the dual-view controller 260, so as to achieve an object of displaying dual-view images. When the dual-view controller 260 reads the left image data 40 and outputs the left image data 40 to the liquid crystal display panel 24, the dual-view controller 260 controls the light source driver 264 to turn on the left light source 202 and turn off the right light source 204. When the dual-view controller 260 reads the right image data 50 and outputs the right image data 50 to the liquid crystal display panel 24, the dual-view controller 260 controls the light source driver 264 to turn on the right light source 204 and turn off the left light source 202.

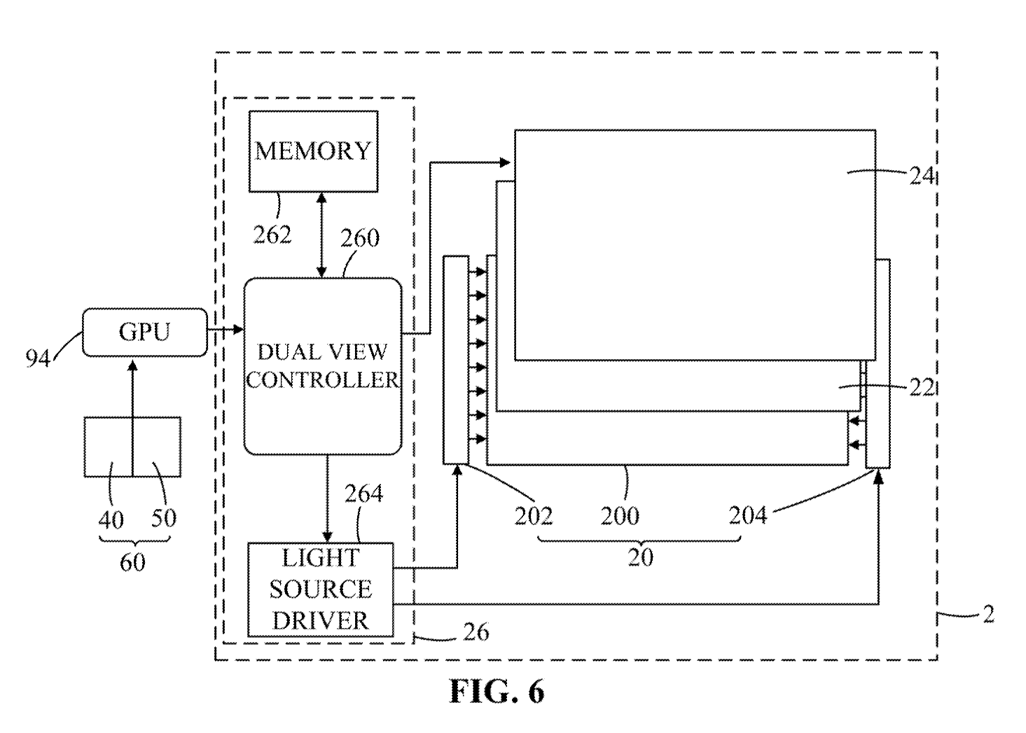

Please refer to FIGS. 2 and 6. FIG. 6 illustrates a third method for inputting the image data. FIGS. 6 and 4 have the same hardware architecture. A difference is that the left image data 40 and the right image data 50 in FIG. 4 are sequentially inputted to the GPU 94, and the left image data 40 and the right image data 50 in FIG. 6 are mixed and encoded into a package 60 then inputted to the GPU 94. Next, the package is inputted to the dual-view controller 260 by the GPU 94. After the dual-view controller 260 receives the package 60, the dual-view controller 260 decodes the package 60 into the left image data 40 and the right image data 50 and stores the left image data 40 and the right image data 50 in different address areas in the memory 262. That is, a specific address area is set to store the left image data 40, and another specific address area is set to store the right image data 50. Next, the dual-view controller 260 reads the left image data 40 and the right image data 50 and outputs the left image data 40 and the right image data 50 to the liquid crystal display panel 24 in turn. The light source driver 264 controls turning-on and turning-off of the left light source 202 and the right light source 204 according to the outputs of the dual-view controller 260, so as to achieve an object of displaying dual-view images. In addition, the left image data 40 and the right image data 50 can be compared to control display methods when the dual-view controller 260 decodes the package 60. When the left image data 40 and the right image data 50 are compared to be the same, the liquid crystal display panel 24 is capable of displaying an identical image for the left-side observer 70 and the right-side observer 80 to see. When only the left image data 40 or the right image data 50 exists, the liquid crystal display panel 24 is capable of displaying one view image for one of the left-side observer 70 and the right-side observer 80 to see.

In summary, the present invention discloses three methods for inputting the left image data 40 and the right image 50 such that: the left image data 40 and the right image 50 are inputted in parallel as shown in FIG. 3, the left image data 40 and the right image 50 are sequentially inputted as shown in FIG. 4, and after the left image data 40 and the right image 50 are mixed and encoded into a package then inputted as shown in FIG. 6. The above-mentioned three methods can adaptively display dual-view images for the left-side observer 70 and the right-side observer 80 to see, respectively, one view image for one of the left-side observer 70 and the right-side observer 80 to see (for example, the left image for the left-side observer 70 to see or the right image for the right-side observer 80 to see), or an identical image for both the left-side observer 70 and the right-side observer 80 to see.

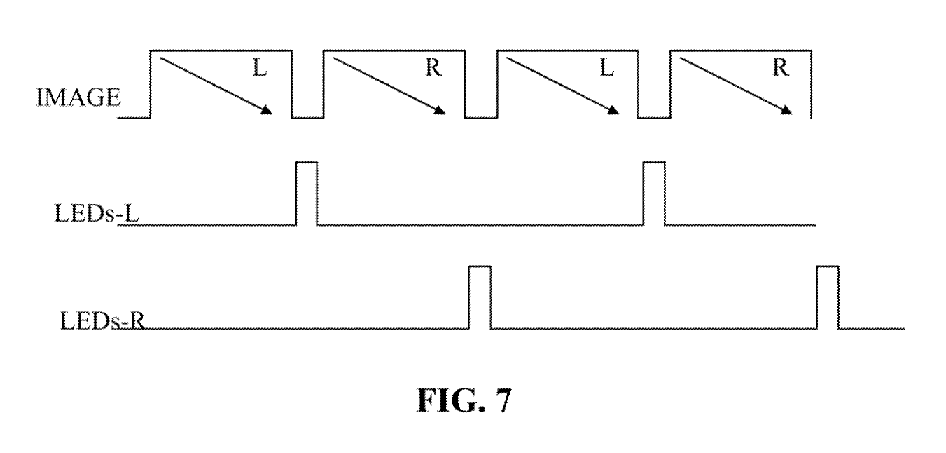

The first is to display dual-view images for the left-side observer 70 and the right-side observer 80 to see, respectively. Please refer to FIG. 7, which illustrates timing diagrams of scanning the images and controlling the left light source 202 and the right light source 204 when displaying dual-view images at 120 Hertz (Hz). Arrows as shown in FIG. 7 represent to finish scanning one image. “L” represents the left image, and “R” represents the right image. LEDs-L and LEDs-R respectively represent driving waveforms of the left light source 202 and the right light source 204. When the architecture as shown in FIG. 3 is adopted to display the dual-view images, the left image data 40 and the right image data 50 are inputted in parallel by the GPUs 90, 92 at 60 Hz. Then the dual-view controller 260 sequentially outputs the left image data 40 and the right image data 50 to the liquid crystal display panel 24 at 120 Hz. When the architecture as shown in FIG. 4 is adopted to display the dual-view images, the left image data 40 and the right image data 50 are sequentially inputted by the GPU 94 at 120 Hz. Then the dual-view controller 260 sequentially outputs the left image data 40 and the right image data 50 to the liquid crystal display panel 24 at 120 Hz. As shown in FIG. 7, the left light source 202 will be turned on after the life image L is scanned and displayed, and the right light source 204 will be turned on after the right image R is scanned and displayed.

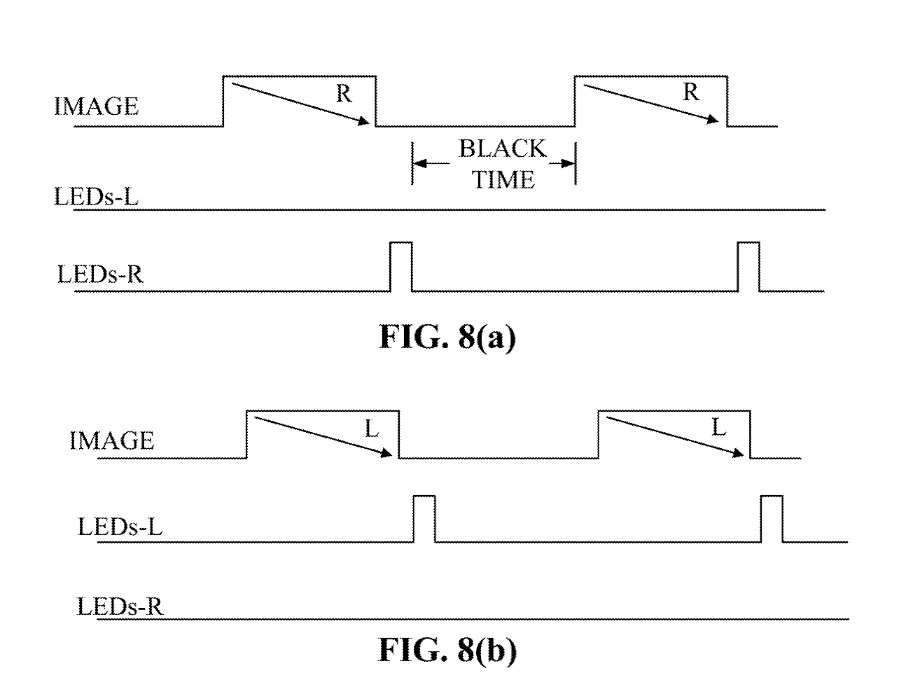

The second is to display one view image for one of the left-side observer 70 and the right-side observer 80 to see. Please refer to FIGS. 8(a) and 8(b), which respectively illustrate timing diagrams of scanning the images and controlling the left light source 202 and the right light source 204 only when the right image R or the left image data L is displayed. As shown in FIG. 8(a), only when the right image R is displayed for the right-side observer 80 to see, the right light source 204 will be turned on after the right image R is scanned and displayed (i.e. after the data of the right image R are inputted to the liquid crystal display panel 24). Since there is no left image L, therefore scanning and displaying the left image L and turning on the left light source 202 are not essential. That is, there has no image displayed between two adjacent right images R. Time between two adjacent right images R having no image displayed is called black time, and the left light source driving waveform is always at a low level, i.e. the left light source 202 is not turned on. On the other hand, as shown in FIG. 8(b), only when the left image L is displayed for the left-side observer 70 to see, the left light source 204 will be turned on after the left image L is scanned and displayed (i.e. after the data of the left image L are inputted to the liquid crystal display panel 24). Since there is no right image R, therefore scanning and displaying the right image R and turning on the right light source 204 are not essential. That is, there has no image displayed between two adjacent left images L. The right light source driving waveform is always at a low level, i.e. the right light source 204 is not turned on.

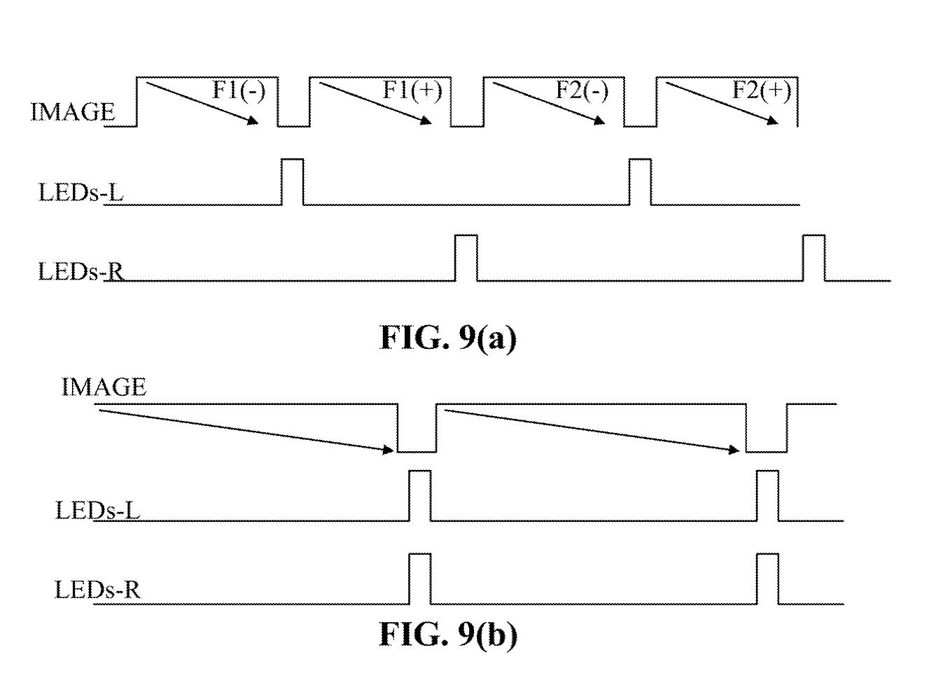

The third is to display an identical image for both the left-side observer 70 and the right-side observer 80 to see. Please refer to FIGS. 9(a) and 9(b), which respectively illustrate timing diagrams of scanning the image and controlling the left light source 202 and the right light source 204 when the identical image is displayed at 120 Hz and 60 Hz. Because the image for the left-side observer 70 to see and the right-side observer 80 to see is the same, the data of the identical image is scanned twice with two opposite polarities, that is, an image F1(−) is scanned and then an image F1(+) is scanned. When the identical image is switched from the image F1(+) to an image F2(+), the polarities of the image F1(+) and the image F2(+) remain unchanged. The left light source 202 will be turned on after the image F1(−) is scanned and displayed, and the right light source 204 will be turned on after the image F1(+) is scanned and displayed. Then, the left light source 202 will be turned on after the image F2(+) is scanned and displayed, and the right light source 204 will be turned on after the image F2(−) is scanned and displayed. FIG. 9(b) is the timing diagram of scanning the identical image and controlling the left light source 202 and the right light source 204 when the identical image is displayed at 60 Hz. In the timing diagram, a scanning time is extended and a scanning frequency is decreased to 60 Hz, and therefore a charged time can be more sufficient.

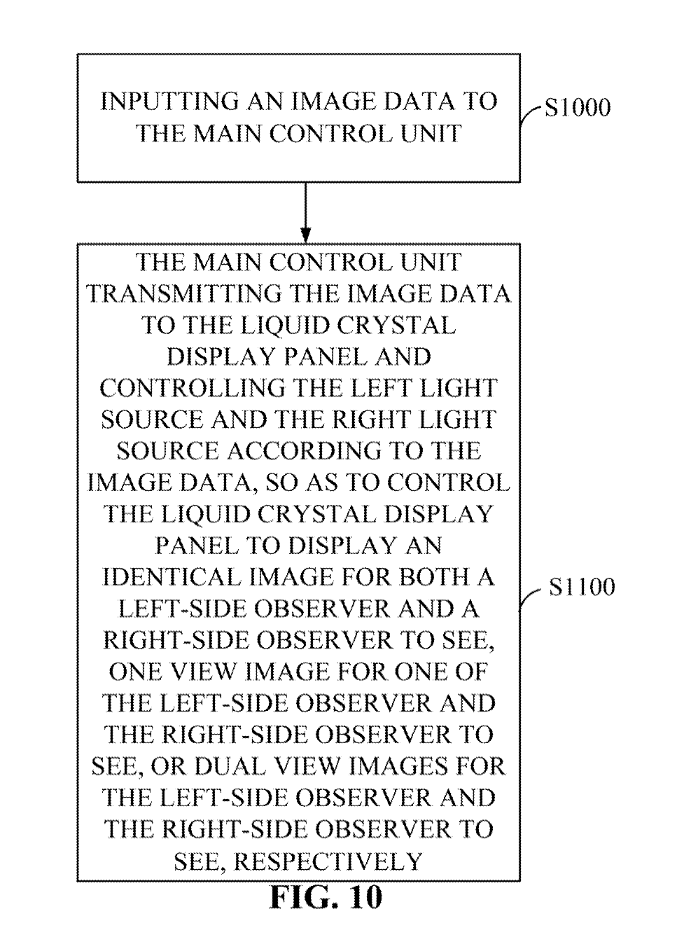

Please refer to FIG. 10, which illustrates a flow chart of a display method of a dual-view display device. The dual-view display device comprises a backlight module, an optical film, a liquid crystal display panel, and a main control unit. The backlight module comprising a light guide plate, a left light source disposed at a left side of the light guide plate, and a right light source disposed at a right side of the light guide plate. The optical film is disposed in front of the backlight module. The liquid crystal display panel is disposed in front of the optical film. The main control unit is electrically coupled to the left light source, the right light source, and the liquid crystal display panel. The display method comprises following steps.

In step S1000, an image data is inputted to the main control unit. The image data comprises a left image data and a right image data. The left image data and the right image data are inputted to the main control unit in parallel, sequentially inputted to the main control unit, or then inputted to the main control unit after the left image data and the right image data are mixed and encoded into a package.

When the left image data and the right image data are sequentially inputted, an indication signal determines which one of the left image data and the right image data is inputted. After the left image data and the right image data are mixed and encoded into the package then inputted, the package is decoded into the left image data and the right image data. Then, the left image data and the right image data are respectively stored in different address areas. Therefore, the left image data and the right image data can be distinguished according to the address areas. Further, the left image data and the right image data can be compared so as to determine an identical image, one view image, or dual-view images is displayed.

In step 1100, the main control unit transmits the image data to the liquid crystal display panel and controls the left light source and the right light source according to the image data, so as to control the liquid crystal display panel to display an identical image for both a left-side observer and a right-side observer to see, one view image for one of the left-side observer and the right-side observer to see (for example, a left image for the left-side observer to see or a right image for the right-side observer to see), or dual-view images for the left-side observer and the right-side observer to see, respectively.

Since a barrier substrate is not essential to be disposed in front of the liquid crystal display panel in the dual-view display device and the display method thereof according to the present invention, the problems, such as a low light transmittance, one half of resolution, and high power consumption, do not exist. Further, the main control unit of the present invention controls the turning-on and turning-off of the left light source and the right light source according to the image data, and thereby an identical image, one view image, or dual-view images can be adaptively displayed.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A display method of a dual-view display device, the dual-view display device comprising a backlight module, an optical film, a liquid crystal display panel, and a main control unit, wherein the backlight module comprises a light guide plate, a left light source disposed at a left side of the light guide plate, and a right light source disposed at a right side of the light guide plate, the optical film is disposed in front of the backlight module, the liquid crystal display panel is disposed in front of the optical film, and the main control unit is electrically coupled to the left light source, the right light source, and the liquid crystal display panel, the display method comprising:
inputting an image data to the main control unit; and
the main control unit transmitting the image data to the liquid crystal display panel and controlling the left light source and the right light source according to the image data, so as to control the liquid crystal display panel to display an identical image for both a left-side observer and a right-side observer to see, one view image for one of the left-side observer and the right-side observer to see, or dual-view images for the left-side and the right-side observers to see, respectively.

2. The display method of the dual-view display device of claim 1, wherein the image data comprises a left image data and a right image data, and the left image data and the right image data are inputted in parallel.

3. The display method of the dual-view display device of claim 1, wherein the image data comprises a left image data and a right image data, and the left image data and the right image data are sequentially inputted.

4. The display method of the dual-view display device of claim 3, wherein which one of the left image data and the right image data is inputted according to an indication signal.

5. The display method of the dual-view display device of claim 1, wherein the left image data and the right image data are mixed and encoded into a package then inputted.

6. The display method of the dual-view display device of claim 5, wherein after the package is decoded into the left image data and the right image data, the left image data and the right image data are respectively stored in different address areas.

7. The display method of the dual-view display device of claim 5, wherein the left image data and the right image data are compared when the package is decoded.
